(19) United States
(12) Patent Application Publication
(10) Pub. No.: US 2017/0276618 A1
(43) Pub. Date: Sep. 28, 2017

(54) GLASS BREAKAGE DETECTION

(71) Applicant: Apple Inc., Cupertino, CA (US)

(72) Inventor: Kazuya Takagi, Tokyo-to (JP)

(21) Appl. No.: 15/078,265

(22) Filed: Mar. 23, 2016

(51) Int. Cl. G01N 21/958; G01N 29/04; G01N 21/55

(52) U.S. Cl. CPC G01N 21/958; G01N 21/55; G01N 29/04; G01N 2291/0289; G01N 2291/0232; G01N 2201/061; G06F 3/0421

(57) ABSTRACT

An electronic device includes one or more emitters, one or more receivers, and a glass or other breakable external component, such as the cover glass of a display. The emitters emit one or more waves that travel via the glass. The receivers are configured to receive the waves from the glass. Damage to the glass, cracks for example, interrupts and/or interferes with travel of the waves via the glass. The electronic device determines the presence and/or absence of damage to the glass based on whether or not the receivers receive the waves. The location of damage to the glass may also be determined.

### FIELD

The described embodiments relate generally to glass or other ceramic components, such as the cover glass of a display. More particularly, the present embodiments relate to detecting breakage of ceramic components.

### BACKGROUND

Many devices include ceramic or other relatively brittle components. These components may be vulnerable to damage. For example, smart phones, wearable electronic devices, and/or other electronic devices may include a cover glass for a touch or other display. These cover glasses may be vulnerable to damage. For example, the cover glass may crack or break when the cover glass impacts a surface, such as when the device is dropped.

This kind of damage may only be recognized by visual inspection. If the user of a device does not notice the damage, the user may continue using the device without seeking repair despite risk of further impairment to the device related to the damage. Even if the user notices the damage, the user may not be aware of the risks. Another party may be aware of the risks, such as a provider of the device, but may not be aware of the damage unless the user informs them. Without awareness, the other party may not have an opportunity to warn the user about continuing to use the damaged device.

### SUMMARY

The present disclosure relates to detecting breakage in a glass or other breakable external component, such as the cover glass of a display. One or more emitters emit one or more waves that travel via the glass. One or more receivers are configured to receive the waves from the glass. Damage to the glass, cracks for example, interrupts and/or interferes with travel of the waves via the glass. The presence and/or absence of damage to the glass is determined based on whether or not the receivers receive the waves. The location of damage to the glass may also be determined based on whether or not the receivers receive the waves.

In various embodiments, an electronic device includes an external component; a sensor operable to receive a signal that travels via the external component; and a processing unit, coupled to the sensor, that determines damage to the external component by determining whether the sensor receives the signal.

In some examples, the external component is optically transparent. In numerous examples, the signal is an optical signal. A wavelength of the optical signal may be outside a visible spectrum.

In various examples, the signal travels through the external component. The signal may travel through the external component due to internal reflection of the signal within the external component. In other examples, the signal travels on a surface of the external component.

In numerous examples, the sensor is located adjacent an edge of the external component. In various implementations of these examples, the electronic device further includes an emitter located adjacent a center of the external component that emits the signal.

In some embodiments, an electronic device includes an optically transparent component; a first emitter operable to emit a first wave which travels via the optically transparent component; a second emitter operable to emit a second wave which travels via the optically transparent component; first and second receivers operable to receive the first and second waves from the optically transparent component; and a processing unit, coupled to the first and second receivers, that determines a location of damage to the optically transparent component by determining which of the first and second receivers receives the first wave or the second wave.

In numerous examples, the first and second emitters are located at first opposing corners of the optically transparent component. In some implementations of these examples, the first and second receivers are located at second opposing corners of the optically transparent component. In various examples, the first emitter and the first receiver are embedded within the optically transparent component.

In some examples, the first and second waves are modulated with different patterns. The first and second waves may be at least one of time multiplexed or frequency multiplexed. In numerous examples, the first wave is an ultrasonic wave.

In numerous embodiments, a method of detecting damage to a glass component includes emitting a signal that travels via the glass component and determining that the glass component is damaged when the signal is not received. In various examples, the method further includes transmitting a notification that the glass component is damaged to an electronic device.

In some examples, the method further includes determining a location of the damage based on not receiving the signal and at least one other signal. In various examples, the method further includes determining a location of the damage based on not receiving the signal and at least one other receiver not receiving the signal.

In numerous examples, the method further includes modulating the signal with a pattern. In these examples, the method may further include emitting an additional signal that travels via the glass component from a different emitter than the signal and modulating the additional signal with an additional pattern that is different from the pattern.

### BRIEF DESCRIPTION OF THE DRAWINGS

The disclosure will be readily understood by the following detailed description in conjunction with the accompanying drawings, wherein like reference numerals designate like structural elements.

FIG. 1 depicts an electronic device with a glass or other breakable external component, such as a cover glass.

FIG. 2 depicts a schematic cross-sectional view of a first example implementation of the electronic device of FIG. 1, taken along line A-A of FIG. 1.

FIG. 3 depicts the schematic cross-sectional view of the electronic device of FIG. 2 after damage to the cover glass.

FIG. 4 depicts a schematic cross-sectional view of a first example configuration of components that may be used in an electronic device, such as the electronic device of FIG. 1, to detect damage to a cover glass, taken along line B-B shown with respect to FIG. 2.

FIG. 5 depicts the schematic cross-sectional view of the electronic device of FIG. 4 after damage to the cover glass.

FIG. 6 depicts a table of various breakage patterns that may be determined using the electronic device of FIG. 4.

FIG. 7 depicts an example of different modulations of the waves emitted by the emitters of the electronic device of FIG. 4.

FIG. 8 depicts a schematic cross-sectional view of a second example configuration of components that may be used in an electronic device, such as the electronic device of FIG. 1, to detect damage to a cover glass, taken along line B-B shown with respect to FIG. 2.

FIG. 9 depicts a schematic cross-sectional view of a third example configuration of components that may be used in an electronic device, such as the electronic device of FIG. 1, to detect damage to a cover glass, taken along line B-B shown with respect to FIG. 2.

FIG. 10 depicts a schematic cross-sectional view of a fourth example configuration of components that may be used in an electronic device, such as the electronic device of FIG. 1, to detect damage to a cover glass, taken along line B-B shown with respect to FIG. 2.

FIG. 11 depicts a schematic cross-sectional view of an electronic device, such as the electronic device of FIG. 1, taken along line A-A of FIG. 1 in accordance with further embodiments.

FIG. 12 depicts the schematic cross-sectional view of the electronic device of FIG. 11 after damage to the cover glass.

FIG. 13 depicts a first example method for detecting damage to a ceramic component such as a cover glass. This first example method may be performed by the electronic devices of FIGS. 1-12.

FIG. 14 depicts a second example method for detecting damage to a ceramic component, such as a cover glass. This second example method may be performed by the electronic devices of FIGS. 1-12.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The description that follows includes sample systems, methods, and apparatuses that embody various elements of the present disclosure. However, it should be understood that the described disclosure may be practiced in a variety of forms in addition to those described herein.

Embodiments described herein relate to detecting breakage in a breakable component or an electronic device, like the cover glass of a display. Waves are emitted that travel via the breakable component, which is typically optically transparent. Damage to the optically transparent component, cracks for example, interrupts, weakens, diffuses, and/or otherwise interferes with travel of the waves via the glass. By monitoring travel of the waves through the material of the component, the presence and/or absence of damage may be determined. In some implementations, the location of damage to the external component may be determined by monitoring the waves. These components may be made of any of a variety of materials, including glass (whether or not chemically strengthened), sapphire, alumina, and so on. The term “glass” is used herein to encompass all such materials, as is the term “cover glass.” The term “ceramic” is used herein to encompass glass. Generally, the component is optically transparent in order to transmit the wave(s) by internal reflection, as described below.

In various implementations, detection of damage to the optically transparent component and/or the location of the damage may be used in a variety of different ways. For example, the electronic device may present information about detected damage, restrict display or other output to undamaged portions, and so on. By way of another example, the electronic device may restrict input to undamaged portions, such as where the optically transparent component is a component of a touch screen. By way of another example, detection of damage may trigger an alert that is provided to a user of the electronic device (for example, via the electronic device or another device), a server or other computing device operated by the provider (for example, the seller, manufacturer, and so on) of the electronic device, and so on.

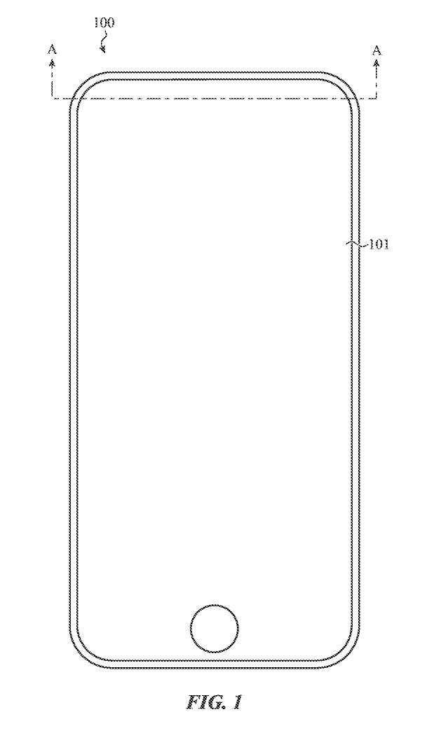

These and other embodiments are discussed below with reference to FIGS. 1-14. However, those skilled in the art will readily appreciate that the detailed description given herein with respect to these Figures is for explanatory purposes only and should not be construed as limiting.

FIG. 1 depicts an electronic device 100 with a glass or other breakable external component, such as a cover glass 101. The electronic device 100 includes components configured to emit waves that travel via (e.g., through, on, and so on) the cover glass 101 and components configured to receive the waves from the cover glass 101. The electronic device 100 is configured to determine damage to the cover glass 101 by determining whether or not one or more of the waves were received. In this way, the electronic device 100 may determine when damage occurs to the cover glass 101 without requiring user intervention or action.

In some implementations, the electronic device 100 may be configured (for example, by including and/or activating one or more communication components) to transmit information regarding a crack, break, or other damage (collectively, “cracks”), or detection of a crack to another electronic device. In some embodiments, the other electronic device may be a server or other computing device operated by the provider (for example, the seller, manufacturer, and so on) of the electronic device 100. The provider may use this information in various ways. For example, the provider may signal the electronic device 100 to present warnings regarding the risks to the electronic device 100 of continuing to operate the electronic device 100, present repair suggestions or warranty information, schedule warranty services, and so on. In other embodiments, the other electronic device may be another device with which the user interacts or has interacted with recently, such as the user's computer in examples where the electronic device is the user's smart phone.

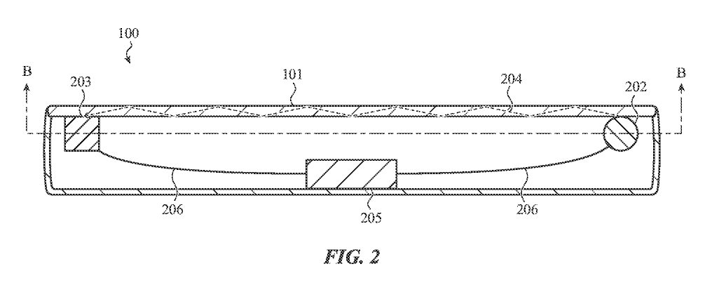

FIG. 2 depicts a schematic cross-sectional view of a first example implementation of the electronic device 100 of FIG. 1, taken along line A-A of FIG. 1. The electronic device 100 may include one or more emitters 202 and one or more receivers 203 or other sensors. The emitter 202 may emit a wave 204 or other signal which travels through the optically transparent cover glass 101 to the receiver 203. The receiver 203 may receive the wave 204 from the cover glass 101.

In this example, the emitter 202 and receiver 203 are coupled to the cover glass 101. The emitter 202 emits the wave 204 into the underside external surface of the cover glass 101. When this internal wave 204 reaches the topside external surface of the cover glass 101, the mismatch in refractive indexes between the cover glass 101 and the surrounding air (or other material adjacent to the cover glass 101) causes the wave 204 to reflect back into the cover glass 101 at an angle. This internal reflection causes the wave 204 to travel along the cover glass 101 until the wave 204 is received by the receiver 203. Generally, the receiver 203 is positioned at a distance from the emitter 202 such that the internally reflected wave impacts a portion of the cover glass 101 adjacent the receiver 203, thereby permitting the wave to be detected by the receiver 203.

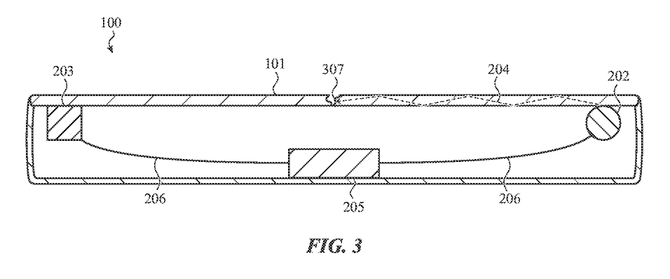

FIG. 3 depicts the schematic cross-sectional view of the electronic device 100 of FIG. 2 after damage 307 to the cover glass 101. As illustrated, the damage 307 is a crack in the cover glass 101. The damage 307 may interrupt, attenuate, and/or otherwise impede travel of the wave 204.

Thus, with reference to FIGS. 2 and 3, receipt of the wave 204 by the receiver 203 indicates that the cover glass 101 is not damaged, whereas failure of the receiver 203 to receive the wave 204 and/or failure of the receiver 203 to receive the wave 204 in the state expected indicates damage 307 to the cover glass 101.

In various implementations, the wave 204 may be an optical wave that the emitter 202 emits into an optically transparent cover glass 101. The optical wave may travel through the glass to the receiver 203. In some implementations, the optical wave may be an optical wave that is outside the visible spectrum (such as below approximately 390 nanometers or above approximately 700 nanometers). For example, optical waves outside the visible spectrum may be infrared waves, ultraviolet waves, and so on. Optical waves outside the visible spectrum may prevent the waves 204 from being visually perceptible to a user and impacting the functionality of the cover glass 101.

The electronic device 100 may also include a processing unit 205 and/or other controller that is coupled to the emitter 202 and the receiver 203, such as by flex circuits 206 and/or another electrical connection. The processing unit 205 may be operable to control the emitter 202 and/or receive information regarding waves 204 received by the receiver 203. Based on the information regarding whether or not the waves 204 were received and/or the state in which the waves 204 were received, the processing unit 205 may determine if the cover glass 101 is damaged. In some implementations, the processing unit 205 may utilize information from multiple receivers 203 to determine a location of the damage 307 in addition to and/or instead of detecting the damage 307.

The location of the processing unit 205 is merely an example. In some embodiments, the processing unit 205 may be affixed to an internal support, circuit board, or the like. The processing unit 205 may be located beneath or adjacent to a display, as another example. Likewise, the emitter(s) 202 and receiver(s) 203 illustrated in FIG. 2 and other figures are illustrative; both emitters and receivers may be placed in different locations within or adjacent to a glass, sapphire, or other component in which damage is to be detected.

Although the emitter 202 and the receiver 203 are coupled to the cover glass 101 in this example, it is understood that other configurations are possible and contemplated without departing from the scope of the present disclosure. For example, in various implementations, the emitter 202 and/or the receiver 203 may be embedded within the cover glass 101. By way of another example, in some implementations, the emitter 202 and/or the receiver 203 may be coupled adjacent to the cover glass 101 rather than coupled to the cover glass 101. In various implementations, the emitter 202 and/or the receiver 203 may be hidden from view through the cover glass 101 by one or more coatings, such as one or more ink layers, decoration layers, and so on. These coatings may allow passage of the wave 204 while obscuring view of the emitter 202 and/or the receiver 203. For example, the obscuring coating or layer may be transparent to a wavelength of the wave, but optically opaque.

Although the electronic device 100 is illustrated and described as including particular components, it is understood that this is an example. In various implementations, the electronic device may include one or more communication components, input/output components, such as touch or other displays, non-transitory storage media (which may take the form of, but is not limited to, a magnetic storage medium; optical storage medium; magneto-optical storage medium; read only memory; random access memory; erasable programmable memory; flash memory; and so on), and so on without departing from the scope of the present disclosure.

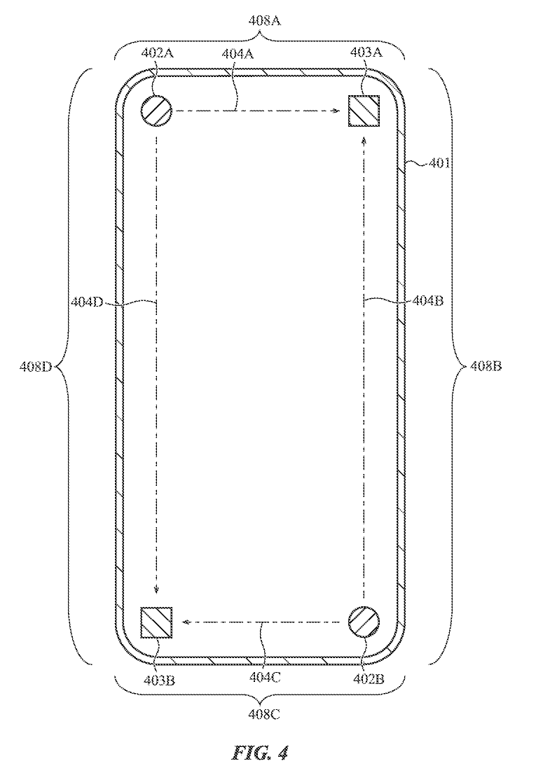

FIG. 4 depicts a schematic cross-sectional view of a first example configuration of components that may be used in an electronic device, such as the electronic device 100 of FIG. 1, to detect damage to a cover glass 401, taken along line B-B shown with respect to FIG. 2. In this first example configuration, multiple emitters 402A, 402B emit waves 404A, 404B, 404C, 404D (e.g., a first emitter 402A emitting first waves 404A and 404D and a second emitter 402B emitting second waves 404B and 404C) or other signals that travel through the cover glass 401. Further in this first example, multiple receivers 403A, 403B (e.g., first and second receivers 403A, 403B) or other sensors may receive the waves 404A, 404B, 404C, 404D from the cover glass 401.

The multiple receivers 403A, 403B may be positioned at opposing corners of the cover glass 401 defined by edges 408A, 408B, 408C, and/or 408D of the cover glass 401. Similarly, the multiple emitters 402A, 402B may be positioned at opposing corners of the cover glass 401.

With multiple receivers 403A, 403B that may receive the waves 404A, 404B, 404C, 404D, the location of damage to the cover glass 401 may be determined. The location of the damage to the cover glass 401 may be determined based on which receivers 403A, 403B receive which waves 404A, 404B, 404C, 404D.

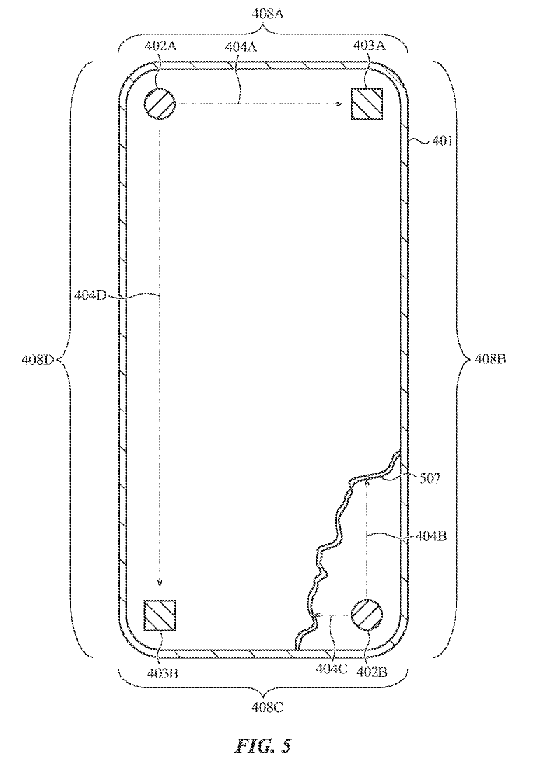

For example, FIG. 5 depicts the schematic cross-sectional view of the electronic device of FIG. 4 after damage 507 to the cover glass 401. In this example, the damage 507 extends from the edge 408B of the cover glass 401 to the edge 408C of the cover glass 401. As such, the damage 507 interrupts travel of the waves 404B, 404C and the waves 404B, 404C are received by neither of the receivers 403A, 403B. Based on this information, it can be determined that the damage 507 is located between the edge 408B and the edge 408C. Further, in this example, the waves 404A, 404D are still received by the receivers 403A, 403B. Based on this information, it can be determined that the damage 507 is not located at and/or between the edges 408A and 408D.

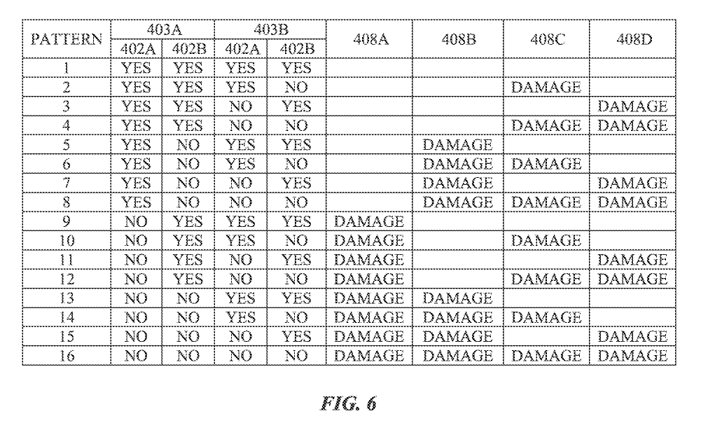

This configuration may enable detection of at least sixteen different breakage patterns that are illustrated in FIG. 6. For example, receipt of all the waves 404A, 404B, 404C, 404D by the receivers 403A, 403B may indicate no damage. This corresponds to Pattern 1 illustrated in FIG. 6. By way of a second example, receipt of the waves 404C, 404D by the second receiver 403B and receipt of the wave 404B but not the wave 404A by the first receiver 403A may indicate the damage 507 is located at the edge 408A. This corresponds to Pattern 9 illustrated in FIG. 6. By way of a third example, receipt of none of the waves 404A, 404B, 404C, 404D by the receivers 403A, 403B may indicate that the damage 507 is located at and/or between all edges 408A, 408B, 408C, and 408D. This corresponds to Pattern 16 illustrated in FIG. 6. A variety of different breakage patterns and/or locations may be determined using this configuration.

As this first example configuration includes multiple emitters 402A, 402B emitting multiple waves 404A, 404B, 404C, 404D that are received by multiple receivers 403A, 403B, various techniques may be utilized to allow the multiple receivers 403A, 403B to distinguish between the multiple waves 404A, 404B, 404C, 404D. For example, the multiple waves 404A, 404B, 404C, 404D may be modulated differently so that the multiple receivers 403A, 403B are able to distinguish between them. The multiple waves 404A, 404B, 404C, 404D may be modulated differently by at least one of time multiplexing, frequency multiplexing, and so on so that the multiple waves 404A, 404B, 404C, 404D are differentiable. Any of these patterns may be used to modulate the waves.

By way of illustration of time multiplexing, the multiple waves 404A, 404B, 404C, 404D may include a unique pattern of pulses. The individual pulses of the unique pattern of pulses of the waves emitted by the emitter 402A typically do not overlap in time with the individual pulses of the unique pattern of pulses of the waves emitted by the emitter 402B, although this may occur if the waves are frequency (or otherwise) multiplexed in such a fashion that they do not destructively interfere with one another.

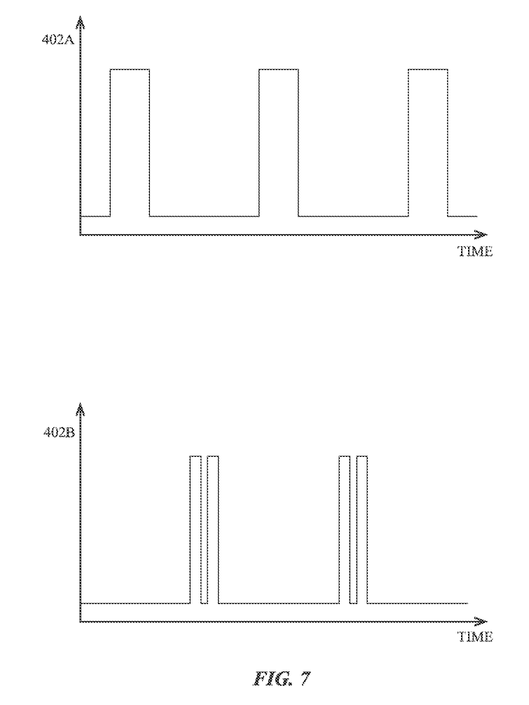

For example, FIG. 7 illustrates an example of different modulations of the waves emitted by the emitters 402A, 402B. The waves emitted by the emitter 402A include a single pulse separated by intervals of time. The waves emitted by the emitter 402B include two pulses that are separated by intervals of time. Further, the single pulses of the waves emitted by the emitter 402A overlap in time with the intervals between dual pulses of the waves emitted by the emitter 402B, whereas the dual pulses of the waves emitted by the emitter 402B overlap in time with the intervals between the single pulses of the waves emitted by the emitter 402A. In this way, the waves emitted by the emitters 402A, 402B can be easily differentiated.

Although FIGS. 4-5 illustrate the emitters 402A, 402B and the receivers 403A, 403B as located at corners of the cover glass 401, it is understood that this is an example. In various implementations, the emitters 402A, 402B and/or the receivers 403A, 403B may be otherwise located without departing from the scope of the present disclosure.

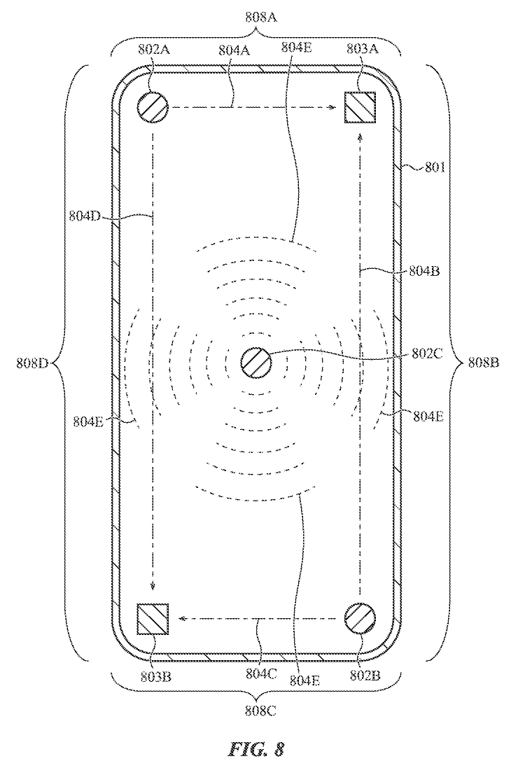

For example, FIG. 8 depicts a schematic cross-sectional view of a second example configuration of components that may be used in an electronic device, such as the electronic device 100 of FIG. 1, to detect damage to a cover glass 801, taken along line B-B shown with respect to FIG. 2. Similar to the first example configuration of FIG. 4, the second example configuration of FIG. 8 includes multiple emitters 802A, 802B that emit multiple waves 804A, 804B, 804C, 804D or other signals that travel through the cover glass 801 and are received by multiple receivers 803A, 803B or other sensors. Contrasted with the first example configuration of FIG. 4, the second example configuration of FIG. 8 includes a third emitter 802C that is operable to emit third waves 804E. The third waves 804E may be radial waves that travel through the cover glass 801 to the receivers 803A and 803B. This second example configuration may allow detection of damage to the cover glass 801 in a greater variety of locations than the first example configuration of FIG. 4.

The first example configuration of FIG. 4 may be unable to detect damage to the cover glass 401 that does not extend to an edge of the cover glass 401 due to the positioning of the emitters 402A, 402B and the receivers 403A, 403B. This may be due to the fact that damage to the cover glass 401 (that does not extend to an edge 408A, 408B, 408C, 408D of the cover glass 401) may not prevent the waves 404A, 404B, 404C, 404D from reaching the receivers 403A, 403B. By way of contrast, the emitter 802C is separated from the receivers 803A, 803B by internal portions of the cover glass 801 rather than edges. As such, damage to these internal portions of the cover glass 801 may prevent one or more of the receivers 803A, 803B from receiving the third waves 804E. Information regarding receipt of the third waves 804E by the receivers 803A, 803B may thus indicate the presence and/or absence of damage to these internal portions of the cover glass 801.

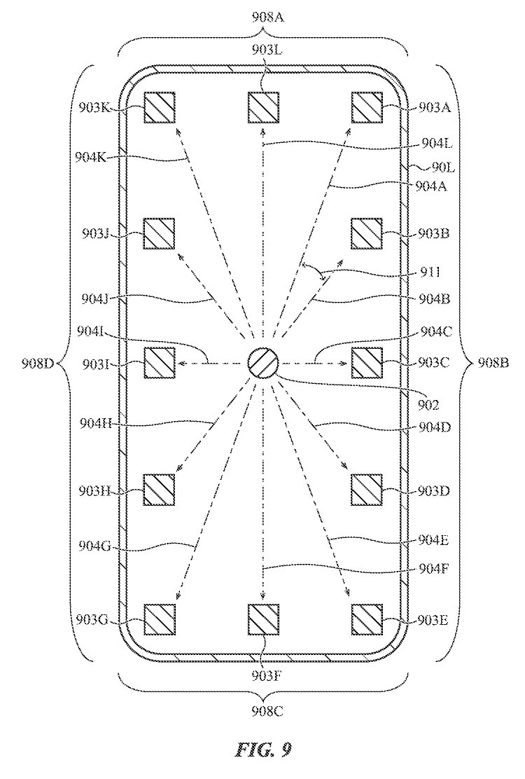

By way of anther example, FIG. 9 depicts a schematic cross-sectional view of a third example configuration of components that may be used in an electronic device, such as the electronic device 100 of FIG. 1, to detect damage to a cover glass 901, taken along line B-B shown with respect to FIG. 2. In this third example configuration, a single centrally located emitter 902 that emits multiple waves 904A-904L or other signals and an array of receivers 903A-903L or other sensors. As the waves 904A-904L radiate outward from the emitter 902 to the receivers 903A-903L, damage within a radius 911 between adjacent waves 904A-904L may be determined by analyzing which receivers 903A-903L receive which waves 904A-904L.

Although FIGS. 2-9 are illustrated and described as using combinations of emitters 202, 402A, 402B, 802A, 802B, 802C, and 902 and receivers 203, 403A, 403B, 803A, 803B, and 903A-903L, it is understood that these are examples. In various implementations, other components, transceivers for example, may be used instead of and/or in addition to the emitters 202, 402A, 402B, 802A, 802B, 802C, and 902 and/or the receivers 203, 403A, 403B, 803A, 803B, and 903A-903L. In such implementations, one or more emitters 202, 402A, 402B, 802A, 802B, 802C, and 902 and/or receivers 203, 403A, 403B, 803A, 803B, and 903A-903L may be components of one or more transceivers.

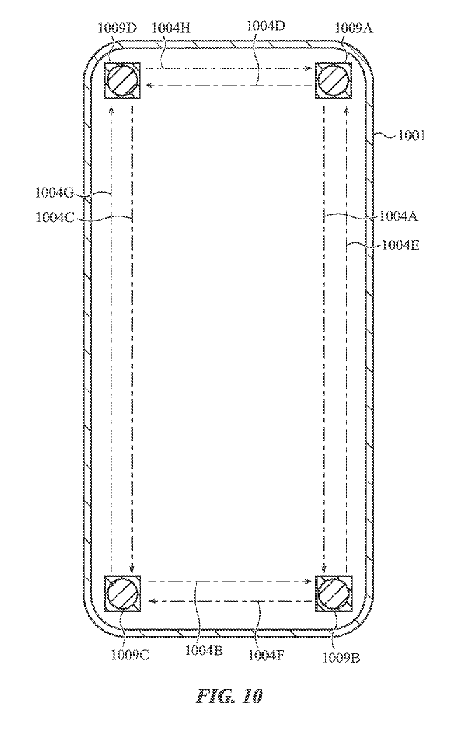

For example, FIG. 10 depicts a schematic cross-sectional view of a fourth example configuration of components that may be used in an electronic device, such as the electronic device 100 of FIG. 1, to detect damage to a cover glass 1001, taken along line B-B shown with respect to FIG. 2. Contrasted with the first example configuration of FIG. 4, the third example configuration of FIG. 10 includes one or more transceivers 1009A, 1009B, 1009C, and 1009D. In this third example configuration, the transceivers 1009A, 1009B, 1009C, and 1009D are positioned at the corners of the cover glass 1001 and are operable to emit and receive waves 1004A, 1004B, 1004C, 1004D, 1004E, 1004F, 1004G, and 1004H or other signals respectively between each other.

For example, the transceiver 1009A may emit first waves 1004A and 1004D which may be received by the transceivers 1009B and 1009D, respectively. Similarly, the transceiver 1009B may emit second waves 1004E and 1004F which may be received by the transceivers 1009A and 1009C, respectively. The transceivers 1009A, 1009B, 1009C, and 1009D may emit and receive the waves 1004A, 1004B, 1004C, 1004D, 1004E, 1004F, 1004G, and 1004H simultaneously and/or at various times, intervals, periods, and so on.

Although FIGS. 2-10 are illustrated and described as using optical waves 204, 404A, 404B, 404C, 404D, 804A, 804B, 804C, 804D, 804E, 904A-904L, 1004A, 1004B, 1004C, 1004D, 1004E, 1004F, 1004G, and 1004H or other optical signals that travel through the cover glasses 101, 401, 801, 901, and 1001, it is understood that these are examples. In various implementations, the waves 204, 404A, 404B, 404C, 404D, 804A, 804B, 804C, 804D, 804E, 904A-904L, 1004A, 1004B, 1004C, 1004D, 1004E, 1004F, 1004G, and 1004H may be other kinds of waves that otherwise travel via the cover glasses 101, 401, 801, 901, and 1001 without departing from the scope of the present disclosure.

In some implementations, the waves 204, 404A, 404B, 404C, 404D, 804A, 804B, 804C, 804D, 804E, 904A-904L, 1004A, 1004B, 1004C, 1004D, 1004E, 1004F, 1004G, and 1004H may be ultrasonic waves. These ultrasonic waves may be surface waves that travel on a surface of the cover glasses 101, 401, 801, 901, and 1001 rather than internal waves that travel through the cover glasses 101, 401, 801, 901, and 1001.

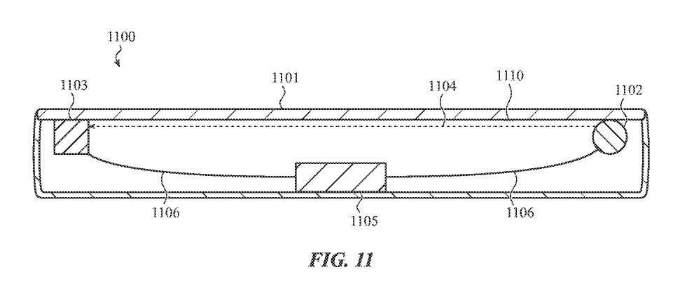

By way of example, FIG. 11 depicts a schematic cross-sectional view of an electronic device 1100, such as the electronic device 100 of FIG. 1, taken along line A-A of FIG. 1 in accordance with further embodiments. Similar to the first example implementation depicted in FIG. 2, the electronic device 1100 includes one or more emitters 1102 that emit one or more waves 1104 or other signals that travel on the cover glass 1101 to one or more receivers 1103 or other sensors. Contrasted with the first example implementation depicted in FIG. 2, the wave 1104 is an ultrasonic surface wave that travels on an external underside surface 1110 of the cover glass 1101.

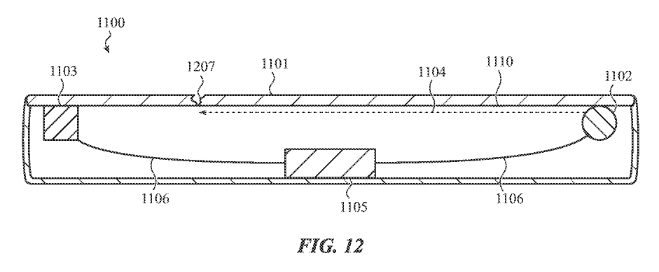

FIG. 12 depicts the schematic cross-sectional view of the electronic device 1100 of FIG. 11 after damage 1207 to the cover glass 1101. As illustrated, the damage 1207 is a crack in the cover glass 1101 that may interrupt and/or impede (such as by attenuating the ultrasonic surface wave 1104) travel of the ultrasonic surface wave 1104. Thus, with reference to FIGS. 11 and 12, receipt of the ultrasonic surface wave 1104 by the receiver 1103 indicates that the cover glass 1101 is not damaged whereas failure of the receiver 1103 to receive the ultrasonic surface wave 1104 and/or failure of the receiver 1103 to receive the ultrasonic surface wave 1104 in the state expected indicates damage 1207 to the cover glass 1101.

Although the electronic device 100 and 1100 is illustrated and described with respect to FIGS. 1-12 as a smart phone, it is understood that this is an example. In various implementations, the electronic device 100 and 1100 may be any kind of a device that includes a breakable external component without departing from the scope of the present disclosure. Such electronic devices may include, but are not limited to, a laptop computing device, a digital media player, a display, a tablet computing device, a wearable electronic device, a cellular telephone, a mobile computing device, a smart watch, and so on.

Further, although the breakable external component is illustrated and described as a cover glass 101, 401, 801, 901, 1001, and 1101 with respect to FIGS. 1-12, it is understood that this is an example. In various implementations, the breakable external component may be any kind of ceramic (for example, one formed of silica or other glass, sapphire, and so on) or other breakable component without departing from the scope of the present disclosure. Typically, a breakable component may transmit waves (such as optical waves) through internal reflection, as described herein.

Additionally, although the emitters 202, 402A, 402B, 802A, 802B, 802C, 902, 1102, receivers 203, 403A, 403B, 8093A, 803B, 903A-903L, 1103 and transceivers 1009A-1009D of FIGS. 2-12 are described as being used to detect damage to cover glasses 101, 401, 801, 901, 1001, 1101, it is understood that these are examples. In various implementations, such components may be used for other purposes, either instead of or in addition to being used to determine damage.

For example, with respect to FIG. 2, contact between the cover glass 101 and an object may affect transmission of the wave 204 through the cover glass 101. For example, travel of the wave 204 through the cover glass 101 may be interrupted, attenuated, and/or otherwise impeded by a user's finger touching the cover glass 101. Thus, interruption, attenuation, and/or other impediment of the wave 204 may be analyzed to determine that the user's finger and/or another object is touching the cover glass 101. In this way, the emitter 202 and the receiver 203 may be used as a touch sensor. In examples where multiple emitters 202 and/or receivers 203 are used, various techniques such as those discussed above may be used to distinguish between waves 204 so as to accurately determine touch and/or location of touch.

In various implementations of such an example, proximity of an object to the cover glass 101 may interrupt, attenuate, and/or impede travel of the wave 204 even when the object is not directly contacting the cover glass 101. The degree of interruption, attenuation, and/or impedance may correspond to the degree of proximity. In these examples, interruption, attenuation, and/or other impediment of the wave 204 may be analyzed to determine the proximity of the object, allowing the emitter 202 and the receiver 203 to be used as a proximity sensor.

By way of another example, movement of the cover glass 101 may interrupt, attenuate, and/or otherwise impede travel of the wave 204. This movement may be caused by a user exerting force on the cover glass 101, causing a portion of the cover glass 101 to bend or otherwise deform. The degree of interruption, attenuation, and/or impedance may correspond to the degree of movement. In these examples, interruption, attenuation, and/or other impediment of the wave 204 may be analyzed to determine the amount of force exerted by the user on the cover glass 101, allowing the emitter 202 and the receiver 203 to be used as a force sensor.

In various other examples, a number of different interactions may affect travel of the wave 204. As such, the wave 204 may be analyzed to determine a variety of different information regarding these interactions and the emitter 202 and/or the receiver 203 may be used as various different sensors.

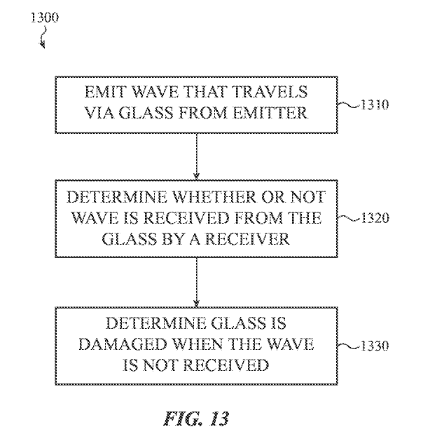

FIG. 13 depicts a first example method 1300 for detecting damage to a ceramic or other breakable external component, such as a cover glass. This first example method 1300 may be performed by the electronic devices 100 and 1100 of FIGS. 1-12.

At 1310, a wave or other signal is emitted that travels within or along a surface of a ceramic or other breakable external component. The wave may be emitted by an emitter, a transceiver, and/or another component. The ceramic component may be a cover glass or other component of a display, such as a touch display.

At 1320, whether or not the wave is received from the ceramic component is determined. The wave may be received from the ceramic component by a receiver, a transceiver, a sensor, and/or another component.

At 1330, the ceramic component is determined to be damaged when the wave is not received.

Although the example method 1300 is illustrated and described as including particular operations performed in a particular order, it is understood that this is an example. In various implementations, various orders of the same, similar, and/or different operations may be performed without departing from the scope of the present disclosure.

For example, the example method 1300 may include the additional and/or alternative operation of determining that the ceramic component is not damaged. The ceramic component may be determined to be undamaged when the wave is received.

By way of another example, the example method 1300 may include the additional operation of determining a location of the damage. The location of the damage may be determined based on the receiver not receiving the wave and at least one other wave, the receiver not receiving the wave and at least one other receiver not receiving the wave, and so on.

By way of yet another example, the example method 1300 may include the additional operation of modulating the wave with a pattern. In such examples, the example method 1300 may further include emitting an additional signal that travels within or along a surface of the ceramic component from an additional emitter and modulating the additional signal with an additional pattern. The additional pattern may be different from the pattern.

By way of still another example, the example method 1300 may include the additional operation of transmitting a notification that the ceramic component is damaged to an electronic device. For example, the electronic device may be a server operated by the provider of the electronic device into which an optically transparent or other external component is incorporated to monitor damage to user electronic devices.

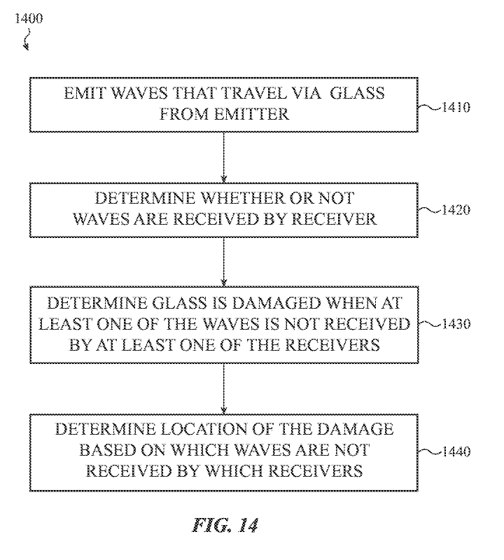

FIG. 14 depicts a second example method 1400 for detecting damage to a ceramic or other breakable external component, such as a cover glass. This second example method may be performed by the electronic devices of FIGS. 1-12.

At 1410, waves that travel via a glass or other breakable external component are emitted from an emitter. At 1420, it is determined whether or not one or more of the waves are received by one or more receivers. At 1430, it is determined that the glass is damaged when at least one of the waves is not received by at least one of the receivers. At 1440, the location of the damage is determined based on which waves are not received by which receivers.

For example, failure of a receiver to receive a particular wave emitted by a particular emitter may indicate damage in an area of the glass between the receiver and that particular emitter. Waves emitted by particular emitters that are received by particular receivers may indicate undamaged areas of the glass between those particular emitters and receivers. Similarly, waves emitted by particular emitters that are not received by particular receivers may indicate damaged areas of the glass between those particular emitters and receivers. In this way, information regarding which waves are and are not received by which receivers may indicate the specific location(s) of damage to the glass.

Although the example method 1400 is illustrated and described as including particular operations performed in a particular order, it is understood that this is an example. In various implementations, various orders of the same, similar, and/or different operations may be performed without departing from the scope of the present disclosure.

For example, the example method 1400 is illustrated and described at 1430-1440 as determining that the glass is damaged and the location of the damage. However, in various situations, all waves may be received by all receivers. In such a situation, the glass may be determined to be undamaged. Thus, the location of damage may not be determined as the glass is not damaged.

As described above and illustrated in the accompanying figures, the present disclosure relates to detecting breakage in a glass or other breakable external component, such as the cover glass of a display. Waves are emitted that travel via the glass. Damage to the glass, cracks for example, interrupts and/or interferes with travel of the waves via the glass. By monitoring travel of the waves through the glass, the presence and/or absence of damage may be determined. In some implementations, the location of damage to the glass may be determined by monitoring the waves.

In the present disclosure, the methods disclosed may be implemented as sets of instructions or software readable by a device. Further, it is understood that the specific order or hierarchy of steps in the methods disclosed are examples of sample approaches. In other embodiments, the specific order or hierarchy of steps in the method can be rearranged while remaining within the disclosed subject matter. The accompanying method claims present elements of the various steps in a sample order, and are not necessarily meant to be limited to the specific order or hierarchy presented.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. An electronic device, comprising:
an external component;
a sensor operable to receive a signal that travels via the external component; and
a processing unit, coupled to the sensor, that determines damage to the external component by determining whether the sensor receives the signal.

2. The electronic device of claim 1, wherein the external component is optically transparent.

3. The electronic device of claim 1, wherein the signal is an optical signal.

4. The electronic device of claim 3, wherein a wavelength of the optical signal is outside a visible spectrum.

5. The electronic device of claim 1, wherein the signal travels through the external component.

6. The electronic device of claim 5, wherein the signal travels through the external component due to internal reflection of the signal within the external component.

7. The electronic device of claim 1, wherein the signal travels on a surface of the external component.

8. The electronic device of claim 1, wherein:
the sensor is located adjacent an edge of the external component; and
the electronic device further includes an emitter located adjacent a center of the external component that emits the signal.

9. An electronic device, comprising:
an optically transparent component;
a first emitter operable to emit a first wave which travels via the optically transparent component;
a second emitter operable to emit a second wave which travels via the optically transparent component;
first and second receivers operable to receive the first and second waves from the optically transparent component; and
a processing unit, coupled to the first and second receivers, that determines a location of damage to the optically transparent component by determining which of the first and second receivers receives the first wave or the second wave.

10. The electronic device of claim 9, wherein:
the first and second emitters are located at first opposing corners of the optically transparent component; and
the first and second receivers are located at second opposing corners of the optically transparent component.

11. The electronic device of claim 9, wherein the first and second waves are modulated with different patterns.

12. The electronic device of claim 11, wherein the first and second waves are at least one of time multiplexed or frequency multiplexed.

13. The electronic device of claim 9, wherein the first emitter and the first receiver are embedded within the optically transparent component.

14. The electronic device of claim 9, wherein the first wave is an ultrasonic wave.

15. A method of detecting damage to a glass component, comprising:
emitting a signal that travels via the glass component; and
determining that the glass component is damaged when the signal is not received.

16. The method of claim 15, further comprising:
determining a location of the damage based on not receiving the signal and at least one other signal.

17. The method of claim 15, further comprising:
determining a location of the damage based on not receiving the signal and at least one other receiver not receiving the signal.

18. The method of claim 15, further comprising:
modulating the signal with a pattern.

19. The method of claim 18, further comprising:
emitting an additional signal that travels via the glass component from a different emitter than the signal; and
modulating the additional signal with an additional pattern that is different from the pattern.

20. The method of claim 15, further comprising transmitting a notification that the glass component is damaged to an electronic device.
